(19) United States
(12) Patent Application Publication
(10) Pub. No.: US 2015/0231857 A1
(43) Pub. Date: Aug. 20, 2015

(54) Multilayer Film

(71) Applicant: Avery Dennison Corporation, Glendale, CA (US)

(72) Inventor: Francis Arnaud, Champ Sur Drac (FR)

(73) Assignee: Avery Dennison Corporation, Glendale, CA (US)

(21) Appl. No.: 14/390,905

(22) PCT Filed: Apr. 5, 2012
(86) PCT No.: PCT/US2012/032293

§ 371 Date: Feb. 19, 2015

(51) Int. Cl. B32B 7/12; B32B 27/32; B32B 27/34; B32B 38/06; B32B 25/08; B32B 27/08; B32B 37/24; B32B 37/12; B32B 5/18; B32B 3/30

(52) U.S. Cl. CPC B32B 7/12; B32B 5/18; B32B 27/32; B32B 27/325; B32B 27/34; B32B 3/30; B32B 25/08; B32B 27/08; B32B 37/24; B32B 37/12; B32B 38/06; B32B 2255/10; B32B 2255/20; B32B 2255/26; B32B 2439/00; B32B 2519/00; B32B 2037/243; B32B 2307/409

(57) ABSTRACT

The present invention is directed to a multilayer film including the layered configuration of a print layer, with the layered configuration of a printable surface coating and a voided thermoplastic material, where the printable surface coating has an embossed surface that extends to the voided thermoplastic material; an adhesive layer; and a liner.

### FIELD

The present invention relates generally to multilayer films used for packaging and commercial display. More specifically, the present invention relates to multilayer films that maintain their appearance and shape when contacted by various elements, including water.

### BACKGROUND

Multilayer films are utilized in various applications as printing substrates. For example, multilayer films may be utilized for packaging, signage and commercial graphic films for advertising and promotional displays.

### SUMMARY

According to an aspect, the present invention is directed to a multilayer film including the layered configuration of a print layer, with the layered configuration of a printable surface coating including a pearlescent coating and a voided thermoplastic material; an adhesive layer; and a liner.

According to another aspect, the present invention is directed to a multilayer film including the layered configuration of a print layer, with the layered configuration of a printable surface coating and a voided thermoplastic material, where the printable surface coating has an embossed surface that extends to the voided thermoplastic material; an adhesive layer; and a liner.

The accompanying drawing, which is incorporated in and constitute a part of this specification, illustrates one or more embodiments of the invention and, together with the description, serves to explain the principles of the invention.

### BRIEF DESCRIPTION OF THE DRAWINGS

A full and enabling disclosure of the present invention, including the best mode thereof directed to one of ordinary skill in the art, is set forth in the specification, which makes reference to the appended drawing, in which:

FIG. 1 is an enlarged side view of multilayer film in accordance with an embodiment of the present invention.

Repeat use of reference characters in the present specification and drawings is intended to represent same or analogous features or elements of the invention.

### DETAILED DESCRIPTION

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

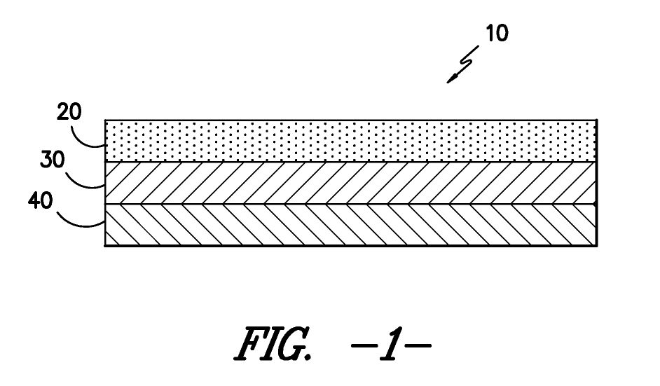

Multilayer films in accordance with embodiments of the present invention are shown in the FIGURE. FIG. 1 illustrates an embodiment of multilayer film 10, in which multilayer film 10 includes a print layer 20, an adhesive layer 30, and a liner 40. As shown in FIG. 1, multilayer film 10 is constructed by successively adhering print layer 20 to adhesive layer 30 and adhesive layer 30 to liner 40. As the Applicants have found, multilayer films of the present invention may serve as an effective graphic display that may include pearlescent-based graphics and textured surfaces while still maintaining the film's structural integrity and graphic display qualities after being exposed to various elements, including water. In many high-end or luxury product markets, including wine, spirits and cosmetics, paper-based labels may be utilized that require enhanced aesthetic elements to effectively display the adhered-to product. In many of these instances, however, the products are exposed to various elements, including water, that can damage the structural integrity and graphic display qualities of the paper-based labels. Such damage may limit a label's effectiveness for advertising and display that is often critical in such markets. By utilizing the multilayer films of the present invention, however, the disadvantages of these labels may be avoided.

As indicated above, multilayer film 10 includes a print layer 20. Print layer 20 serves as part of the graphical display for which multilayer film is utilized. As such, print layer 20 may be constructed of various thermoplastic materials that are receptive to inks. For example, in some embodiments, print layer 20 may be constructed of polyethylene, such as high density polyethylene (HDPE) and/or low density polyethylene (LDPE). In additional embodiments, print layer 20 may be constructed of polypropylene, polyethylene terephthalate, polyamide, or other thermoplastics. The user's specifications will dictate the particular materials utilized for forming the print layer 20.

In some embodiments of the present invention, additional dyes and/or pigments may be added to print layer 20 to aid in the graphic display application of multilayer film 10. For example, such additional materials may be utilized to provide a print layer 20 that is white or opaque, color translucent, colored opaque, matte or glossy.

The thermoplastic material utilized for print layer 20 may be a voided thermoplastic material such that the density of the thermoplastic material is not more than about 0.85 g/cm³. In other embodiments, the voided thermoplastic material may have a density of not more than about 0.9 g/cm³. The voided thermoplastic material of the present invention may aid in providing tamper-evident properties to multilayer film 10, such that portions of multilayer film 10 remain on the adhered-to surface if there is an attempt to remove multilayer film 10.

To aid in the adherence of ink, print layer 20 may further include additional coatings. For example, in some embodiments, a printable surface coating including a polymeric binder, an absorbent pigment and an antistatic agent may be utilized. The antistatic agent utilized may be any known in the art, including sodium polyphosphate, and may constitute between about 0.4 and 2.5 weight percent of the total weight of the printable surface coating.

In addition, the polymeric binder may be any known polymer for use in print surface coatings, including acrylic polymer or copolymer, or a vinyl acetate polymer or copolymer. In addition, the binder may constitute between about 15 and 50 weight percent of the total weight of the printable surface coating. The absorbent pigment of the printable surface coating may be any dispersible solid, including calcium carbonate, china clay, or titanium oxide. The user's specifications will dictate the particular components and the weight ratios of each that are utilized.

Print layers 20 suitable for the present invention include those having a weight of between about 60 g/m² and about 285 g/m². For example, in some embodiments, print layer 20 may have a weight of about 90 g/m². In addition, the thickness of print layer 20 may range from about 80 μm to about 350 μm. For example, in some embodiments, print layer 20 may have a thickness of about 110 μm. Suitable materials that may be utilized with the present invention as print layer 20 include the components described above and are available under the trade name of Polyart from Arjobex, Limited of Essex, Great Britain.

As indicated above, additional coatings or texture effects may be applied to print layer 20 of the present invention. For example, Applicants have found that pearlescent coatings may be applied to print layer 20 after its construction to enhance the aesthetic qualities of multilayer film 10, and still allow for the enhanced protective effects against various elements. In addition, pearlescent coating may provide additional luster effects to multilayer film, where light striking the coating is partially reflected and partially transmitted through the platelets of the pearlescent coating. Such luster effects may be beneficial for proper shelf advertising for the products for which multilayer film is used in connection with, including those luxury items described above. The pearlescent coatings of the present invention may be applied to the entirety of print layer 20 or to individual portions of print layer 20 depending on the user's specifications. For example, in some embodiments, pearlescent coating may only be applied to particular text or graphics on print layer 20, or, in additional embodiments, pearlescent coating may be applied to the entirety of print layer 20 to give the entire multilayer film 10 a luster effect.

Any method known in the art for the application of a pearlescent coating may be utilized in connection with the present invention. For example, in some embodiments, pearlescent coating may be applied by a spray coating or may be applied by brush coating. The user's specifications may dictate the particular application method utilized.

In addition, print layer 20 may be embossed to provide textured effects sometimes found on paper-based labels. However, as explained above, print layers 20 of the present invention avoid some of the pitfalls of paper-based labels by providing sustained structural integrity and graphical displays despite being exposed to various elements, including water. The methods for providing the embossed effects that may be applied to print layer 20 include those known in the art, where the embossing extends from the printable surface coating to the thermoplastic material. For example, various forms of mechanical and physical embossing may be utilized with respect to the present invention. In addition, based on the user's specifications, any known design or embossing effect may be utilized. For example, in some embodiments, print layer 20 may include a symbol or graphic embossing that signifies the particular product to which multilayer film is adhered. The user's specifications will dictate the particular embossing utilized.

As illustrated in FIG. 1, adhesive layer 30 is sandwiched between print layer 20 and liner 40. Adhesive layer 30 of the present invention may have a thickness in the range of from about 0.1 to about 2 mils. Adhesives suitable for use as adhesive layer 30 for multilayer films 10 of the present invention are commonly available in the art. Generally, these adhesives include pressure-sensitive adhesives, heat-activated adhesives, hot-melt adhesives, and others. Suitable pressure-sensitive adhesive include acrylic based adhesives as well as other elastomers such as natural rubber or synthetic rubbers containing polymers or copolymers of styrene, butadiene, acrylonitrile, isoprene, and isobutylene.

Pressure-sensitive adhesives are known in the art and any of the known adhesives may be used in connection with multilayer film adhesive layer 30 of the present invention. In one embodiment, adhesive layer 30 may include copolymers of acrylic acid esters, such as, for example, 2-ethyl hexyl acrylate, with polar comonomers such as acrylic acid.

As indicated above, liner 40 is attached to adhesive layer 30 opposite print layer 20 in the construction of multilayer film 10. Liner 40 may include a multilayer liner made, for example, as disclosed in U.S. Pat. No. 4,713,273, the disclosure of which is incorporated herein in its entirety by reference thereto. In additional embodiments, liner 40 may be a conventional liner including a single paper or film layer which may be supplied in roll form. In further embodiments, liner 40 may be coated with a release coating (e.g., a silicone), that may be, in some embodiments, dried or cured following application by any suitable means.

In further embodiments of the present invention, adhesive layer 30 may be a heat-activated adhesive or a hot-melt adhesive such as used in in-mold label applications, as distinguished from a pressure-sensitive adhesive. If adhesive layer 30 includes a heat-activated adhesive or hot-melt adhesive, there may be no need for liner 40 to have inherent releaseability such as required when using a pressure-sensitive adhesive.

As indicated above, multilayer film 10 is constructed by successively adhering print layer 20 to adhesive layer 30 and adhesive layer 30 to liner 40. In the construction of multilayer film 10, the various components may be applied in any order required by the user. For example, in some embodiments, a pearlescent coating may be applied to print layer 20 and then print layer 20 may be embossed, with adhesive layer 30 then being applied to print layer 20 and liner 40 then being adhered to adhesive layer 30. The user's specifications will dictate the order utilized.

As discussed above, the multilayer films of the present invention provide advantages due to their applicability to various packaging and display items, including products in luxury markets, through enhanced graphic and textured displays with the ability to maintain their structural integrity while being exposed to various elements, including water. Such advantages of the present invention may prove beneficial for various wines or spirits that require emersion in an ice bath prior to being served and/or consumed. As the Applicants have found, when utilizing the multilayer films of the present invention for the production of such product labels, the visual aspects of whiteness, opacity, and dimensional characteristics may be maintained. Again, as discussed above, existing paper-based labels do not provide such advantages and tend to lose many of their dimensional and graphic qualities following emersion.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged in whole or in part. Furthermore, those of ordinary skill in the art will appreciate that the foregoing description is by way of example only, and is not intended to limit the invention so further described in such appended claims. Therefore, the spirit and scope of the appended claims should not be limited to the description of the versions contained therein.

1. A multilayer film comprising the following layered configuration:
a print layer comprising the following layered configuration:
a printable surface coating comprising a pearlescent coating, and
a voided thermoplastic material;
an adhesive layer having two opposing sides with one side attached to the print layer; and
a liner attached to the other of the adhesive layer's opposing side.

2. The multilayer film of claim 1, wherein the pearlescent coating covers a portion of the print layer.

3. The multilayer film of claim 1 or 2, wherein the pearlescent coating covers an entire surface of the print layer.

4. The multilayer film of claim 1, wherein the voided thermoplastic material comprises polyethylene.

5. The multilayer film of claim 1, wherein the voided thermoplastic material comprises high density polyethylene.

6. The multilayer film of claim 1, wherein the voided thermoplastic material is selected from the group consisting of polypropylene, polyethylene terephthalate, or polyamide.

7. The multilayer film of claim 1, wherein the density of the voided thermoplastic material is not more than about 0.85 g/cm³.

8. The multilayer film of claim 1, wherein the density of the voided thermoplastic material is not more than about 0.9 g/cm³.

9. The multilayer film of claim 1, wherein the printable surface coating comprises a polymeric binder, an absorbent pigment, and an antistatic agent.

10. The multilayer film of claim 9, wherein the absorbent pigment is selected from the group consisting of calcium carbonate, china clay, or titanium oxide.

11. The multilayer film of claim 9, wherein the absorbent pigment comprises between about 47.5 and 80 weight percent of the total weight of printable surface coating.

12. The multilayer film of claim 1, wherein the print layer has a weight between about 60 g/m² and about 285 g/m².

13. The multilayer film of claim 1, wherein the print layer has a weight of about 90 g/m².

14. The multilayer film of claim 1, wherein the thickness of the print layer is between about 80 μm to about 350 μm.

15. The multilayer film of claim 1, wherein the thickness of print layer is about 110 μm.

16. A multilayer film comprising the following layered configuration:
a print layer comprising the following layered configuration:
a printable surface coating; and
a voided thermoplastic material wherein the printable surface coating has an embossed surface that extends to the voided thermoplastic material,
an adhesive layer having two opposing sides with one side attached to the print layer; and
a liner attached to the other of the adhesive layer's opposing sides.

17. The multilayer film of claim 16, wherein the embossed surface comprises a diamond shape.

18. The multilayer film of claim 16, wherein the voided thermoplastic material comprises polyethylene.

19. The multilayer film of claims 16 and 18, wherein the voided thermoplastic material comprises high density polyethylene.

20. The multilayer film of claim 16, wherein the voided thermoplastic material is selected from the group consisting of polypropylene, polyethylene terephthalate, or polyamide.

21. The multilayer film of claim 16, wherein the density of the voided thermoplastic material is not more than about 0.85 g/cm³.

22. The multilayer film of claim 16, wherein the density of the voided thermoplastic material is not more than about 0.9 g/cm³.

23. The multilayer film of claim 16, wherein the printable surface coating comprises a polymeric binder, an absorbent pigment, and an antistatic agent.

24. The multilayer film of claim 23, wherein the absorbent pigment is selected from the group consisting of calcium carbonate, china clay, or titanium oxide.

25. The multilayer film of claim 23, wherein the absorbent pigment comprises between about 47.5 and 80 weight percent of the total weight of printable surface coating.

26. The multilayer film of claim 16, wherein the print layer has a weight between about 60 g/m² and about 285 g/m².

27. The multilayer film of claim 16, wherein the print layer has a weight of about 90 g/m².

28. The multilayer film of claim 16, wherein the thickness of the print layer is between about 80 μm to about 350 μm.

29. The multilayer film of claim 16, wherein the thickness of the print layer is about 110 μm.

30. A multilayer film comprising the following layered configuration:
a print layer comprising the following layered configuration:
a printable surface coating comprising a pearlescent coating; and
a voided thermoplastic material wherein the printable surface coating has an embossed surface that extends to the voided thermoplastic material,
an adhesive layer having two opposing sides with one side attached to the print layer; and
a liner attached to the other of the adhesive layer's opposing sides.

31. The multilayer film of claim 30, wherein the pearlescent coating covers a portion of the print layer.

32. The multilayer film of claim 30, wherein the pearlescent coating covers an entire surface of the print layer.

33. The multilayer film of claim 30, wherein the voided thermoplastic material comprises polyethylene.

34. The multilayer film of claim 30, wherein the voided thermoplastic material comprises high density polyethylene.

35. The multilayer film of claim 30, wherein the voided thermoplastic material is selected from the group consisting of polypropylene, polyethylene terephthalate, or polyamide.

36. The multilayer film of claim 30, wherein the density of the voided thermoplastic material is not more than about 0.85 g/cm³.

37. The multilayer film of claim 30, wherein the density of the voided thermoplastic material is not more than about 0.9 g/cm³.

38. The multilayer film of claim 30, wherein the printable surface coating comprises a polymeric binder, an absorbent pigment, and an antistatic agent.

39. The multilayer film of claim 38, wherein the absorbent pigment is selected from the group consisting of calcium carbonate, china clay, or titanium oxide.

40. The multilayer film of claim 38, wherein the absorbent pigment comprises between about 47.5 and 80 weight percent of the total weight of printable surface coating.

41. The multilayer film of claim 30, wherein the print layer has a weight between about 60 g/m² and about 285 g/m².

42. The multilayer film of claim 30, wherein the print layer has a weight of about 90 g/m².

43. The multilayer film of claim 30, wherein the thickness of the print layer is between about 80 μm to about 350 μm.

44. A method of forming a multilayer film, the method comprising:
adhering a print layer to a surface of an adhesive layer, wherein the print layer comprises the following layered configuration:
a printable surface coating, and
a voided thermoplastic material;
adhering a liner to the opposite surface of the adhesive layer;
applying a pearlescent coating to the printable surface coating; and
embossing the print layer.

45. The method of claim 44, wherein the pearlescent coating is applied to a portion of the print layer.

46. The method of claim 45, wherein the pearlescent coating is applied to an entire surface of the print layer.

47. The method of claim 44, wherein the voided thermoplastic material comprises polyethylene.

48. The method of claim 41, wherein the voided thermoplastic material comprises high density polyethylene.

49. The method of claim 44, wherein the voided thermoplastic material is selected from the group consisting of polypropylene, polyethylene terephthalate, or polyamide.

50. The method of claim 44, wherein the density of the voided thermoplastic material is not more than about 0.6 g/m³.

51. The method of claim 44, wherein the density of the voided thermoplastic material is not more than about 0.5 g/m³.

52. The method of claim 44, wherein the printable surface coating comprises a polymeric binder, an absorbent pigment, and an antistatic agent.

53. The method of claim 52, wherein the absorbent pigment is selected from the group consisting of calcium carbonate, china clay, or titanium oxide.

54. The method of claim 52, wherein the absorbent pigment comprises between about 47.5 and 80 weight percent of the total weight of printable surface coating.

55. The method of claim 44, wherein the print layer has a weight between about 75 g/m² and about 285 g/m².

56. The method of claim 44 or 55, wherein the print layer has a weight of about 90 g/m².

57. The method of claim 44, wherein the thickness of print layer is between about 95 μm to about 350 μm.

58. The method of claim 44, wherein the thickness of print layer is about 110 μm.

59. The method of claim 44, wherein the method comprises the following steps in the following order:
the pearlescent coating is first applied to the printable surface coating; and then the print layer is embossed,
the print layer is then adhered to the adhesive layer, and
the liner is then adhered to the adhesive layer.
